(19) United States
(12) Patent Application Publication
(10) Pub. No.: US 2026/0340794 A1
(43) Pub. Date: Oct. 29, 2026

(54) METHOD AND ELECTRONIC DEVICE FOR CORRECTING PERSPECTIVE DISTORTION

(71) Applicant: SAMSUNG ELECTRONICS CO., LTD., Suwon-si (KR)

(72) Inventors: Dmitrii Yurevich GUDKOV, Moscow (RU); Andrey Igorevich PALAEV, Moscow (RU); Renat Maratovich BASHIROV, Moscow (RU)

(21) Appl. No.: 19/657,612

(22) Filed: Apr. 24, 2026

Related U.S. Application Data
(63) Continuation of application No. PCT/KR2026/096225, filed on Apr. 23, 2026.

(30) Foreign Application Priority Data
Apr. 24, 2025 (RU) 2025110620
Aug. 5, 2025 (RU) 2025121584

(51) Int. Cl. G06T 5/80; G06T 3/40; G06T 3/60; G06T 5/60; G06T 7/10; G06T 7/50; G06V 40/16

(52) U.S. Cl. CPC G06T 5/80; G06T 3/40; G06T 3/60; G06T 5/60; G06T 7/10; G06T 7/50; G06V 40/162; G06T 2207/20084; G06T 2207/30201

(57) ABSTRACT

A method, performed by an electronic device, for correcting perspective distortion in a digital image may be provided. The method may include obtaining an input image. The method may include processing the input image into a canonical image. The method may include obtaining an input angle for the input image. The method may include obtaining an output angle to be used for generating the output image. The method may include providing the input angle, the output angle and the canonical image as inputs to a pre-trained multi-task neural network model for correcting perspective distortion. The method may include outputting an image with corrected perspective distortion as the output image.

### CROSS-REFERENCE TO RELATED APPLICATIONS

This application is a continuation application of International Application No. PCT/KR2026/096225, filed on Apr. 23, 2026, in the Korean Intellectual Property Receiving Office, and claiming priority to RU 2025110620 filed Apr. 24, 2025 and RU 2025121584 filed Aug. 5, 2025, the disclosures of which are all hereby incorporated by reference herein in their entireties.

### FIELD

An embodiment may relate to digital image processing, for example to a method and/or apparatus for correcting perspective distortion in digital images such as human portraits in an end-to-end fashion without optimization using deep learning models, and may be implemented e.g., in a computational device having a camera (e.g. a smartphone and/or a laptop) able to perform visual analysis.

### BACKGROUND

Portrait digital photography, such as e.g. selfie-taking, has become an aspect of modern life, with millions of images shared daily on social media platforms. While much attention has been paid to selfie editing in recent years-covering areas such as lighting adjustments, object manipulation, and beautification, perspective distortion remains an unresolved challenge, particularly in selfies captured at close distances. As such, portrait photographs taken from short distances may contain perspective distortion that deforms facial features and makes faces look unnatural. Close-up portraits often suffer from severe distortions affecting the overall appearance, so that a face might become weirdly-looking due to hypertrophied prominent parts, or even unrecognizable. This problem, at least partially caused by the inherent design of cameras, can result in exaggerated facial features such as disproportionately large ears, lips, and noses. These distortions not only affect the perceived aesthetics of the image but also render the faces depicted as unnatural.

It should be noted that, while various portrait image employing applications, such as those enabling video streaming (e.g., conference calls, video blogging), may require compensating image distortions for the purpose of providing an aesthetically better image, other applications that perform visual analysis from portraits (e.g., person identification or verification) may also require images free from perspective distortions for the purpose of more precise and reliable person identification or verification. In general, all these usage scenarios may require undistorted, clearly identifiable faces shot with a proper distance between face and camera.

The problem of distortions in human digital portrait photographs may be addressed by correcting perspective distortion. On the whole, this may be done e.g. using some distortion correcting tools such as provided in image editing suites.

Related techniques that try to solve this problem (such as e.g. selfie undistortion and head pose editing with identity preservation (SUPER), portrait distortion correction with perspective-aware 3d gans (DisCO)), require time-consuming optimization for each input image and consist of multiple components. Related methods for addressing perspective distortion have largely relied on warping. While these methods have made strides in correcting distortion, preserving the details of the original image, they often fall short in producing natural-looking results and struggle to restore occluded facial parts due to their lack of generative capabilities.

Recent advancements have introduced multi-view synthesis techniques for portrait images to mitigate perspective distortion. These methods typically involve reconstructing the subject from the input image through an inversion of a 3D aware Generative Adversarial Network (GAN), which enables rendering the subject at a greater distance from the camera.

However, these approaches require an optimization stage during inference and face challenges in maintaining the subject's identity and high-frequency details.

Some other approaches have tried to replace optimization-based 3D-GAN inversion with encoder-based 3D GAN inversion to decrease inference time. However, they often suffer from poor image fidelity and fail to preserve the subject identity.

Recent state-of-the-art methods, DisCO and SUPER, combine generative models with warping techniques to enhance results.

So, a related art discloses an approach based on a pipeline for correcting portrait distortion using perspective-aware 3D GAN inversion, which utilizes pre-trained 3D GANs to invert the portrait into its corresponding face latent code and camera parameters. Here, first a 3D morphable model (3DMM) model is fitted to the image to get an initial camera pose and average randomly sampled latent codes to initialize the face latent code. Then, the face latent code, generator, and neural renderer are fixed to optimize camera parameters. Focal length and rotation are re-parameterized. After optimizing the camera poses, face latent code and camera parameters are simultaneously optimized. Then, fine-tuning of the generator is performed to achieve high-fidelity results on real images.

Although these approaches produce high-quality outputs, they require optimization at inference time, limiting their applications.

A related art discloses a learning-based method to remove perspective distortion from portraits, which operates based on a feedforward mode. This related art method pre-processes the input portraits with background segmentation, scaling, and spatial alignment, and then feeds them to a camera distance prediction network to estimate camera-to-subject distance. Then the estimated distance and the portrait are fed into a cascaded network, which predicts a distortion correction flow map and inpaints any missing facial features caused by perspective distortion. Thus, image undistortion in this related art solution consists of two main steps: finding a per-pixel undistortion flow map, and image completion via inpainting.

However, this related art approach struggles with large occlusions and head poses and does not control the distortion level in both input and output.

A related art discloses systems and methods for automatically correcting apparent distortions in close range photographs that are captured using an imaging system capable of capturing images and depth maps are disclosed. In the related art solution, faces are automatically detected and segmented from images using a depth-assisted alpha matting. The detected faces are then re-rendered from a more distant viewpoint and composited with the background to create a new image in which apparent perspective distortion is reduced. In particular, this related art discloses detecting a face within the image data and a distance from the initial viewpoint to the face from the depth map data; segmenting face image data from background image data using the depth map data; re-rendering the face from a synthetic viewpoint by warping the segmented face image data based upon the depth map data to generate warped face image data, where the synthetic viewpoint is a greater distance from the face along an optical axis relative to the distance from the initial viewpoint to the face. According to this related art solution, the warping corrects perspective distortion in the segmented face image data resulting from camera optics by: projecting the segmented face image data to 3D locations based upon distances to pixels within the segmented face image data contained within the depth map data; re-projecting the 3D locations to new 2D pixel locations based upon the desired viewpoint distance to create warped face image data; filling holes in the warped face image data.

Among the drawbacks of this related art solution, one may note the need for multiple cameras, as well as the need for more additional data to perform the processing for removing perspective distortion from an image, such as depth map data. The related art solution has higher complexity since it relies on projection to 3D locations and back, produces “holes” in the warped face image data, and uses a trimap.

A related art discloses a system, method, and apparatus for generating a normalization of a single two-dimensional image of an unconstrained human face. The related art system receives a single two-dimensional image of an unconstrained human face, generates an undistorted face based on the unconstrained human face by removing perspective distortion from the unconstrained human face. For normalization of facial images, the related art system uses deep neural networks, and uses a perspective undistortion network to remove perspective distortion from the unconstrained human face. Removing perspective distortion in the related art solution includes performing three-dimensional face fitting to the undistorted face to obtain a fitted three-dimensional mesh, spherical harmonics shading coefficients, and UV texture. Then, the related art system uses a lighting translation network to generate an evenly lit face based on the undistorted face by normalizing lighting of the undistorted face, and uses an expression neutralization network to generate a frontalized and neutralized expression face based on the evenly lit face. The related art system predicts a dense two-dimensional flow based on the image and two-dimensional landmarks detected in the image to generate the undistorted face. In this related art solution, the perspective undistortion network is a generative adversarial network trained via dense flow fields by fitting three-dimensional face models to input images with known focal length and camera-to-subject distance.

Among the drawbacks of this related art solution, one may note its high complexity due to the need to train and use of multiple different neural networks for specific steps of the related art technique as mentioned above, as well as complex data processing that involves changing lighting conditions of the face image, as well as changing facial expression of the person's face within the image, determining and passing landmarks in the face image to respective neural network(s).

### SUMMARY

This section which discloses various aspects is intended for providing a brief overview of an embodiment. Detailed characteristics of technical means and methods that implement the combinations of features of example embodiments are provided hereinbelow. Neither this summary nor the detailed description provided below together with accompanying drawings should be regarded as defining the scope of the claims. The scope of legal protection of the claimed invention is only defined by the appended set of claims.

In an embodiment, a method, performed by an electronic device, for correcting perspective distortion in a digital image may be provided. In an embodiment, the method may include obtaining an input image. In an embodiment, the method may include processing the input image into a canonical image. In an embodiment, the method may include obtaining an input angle for the input image. In an embodiment, the method may include obtaining an output angle to be used for generating the output image. In an embodiment, the method may include providing the input angle, the output angle and the canonical image as inputs to a pre-trained multi-task neural network model for correcting perspective distortion. In an embodiment, the method may include outputting an image with corrected perspective distortion as the output image.

In an embodiment, an electronic device for correcting perspective distortion in a digital image may be provided. In an embodiment, the electronic device may include at least one processor, comprising processing circuitry, and memory storing instructions. In an embodiment, the instructions, when executed individually or collectively by the at least one processor, may cause the electronic device to obtain an input image. In an embodiment, the instructions, when executed individually or collectively by the at least one processor, may cause the electronic device to process the input image into at least a canonical image. In an embodiment, the instructions, when executed individually or collectively by the at least one processor, may cause the electronic device to obtain an input angle for the input image. In an embodiment, the instructions, when executed individually or collectively by the at least one processor, may cause the electronic device to obtain an output angle to be used for generating the output image. In an embodiment, the instructions, when executed individually or collectively by the at least one processor, may cause the electronic device to provide the input angle, the output angle and the canonical image as inputs to a pre-trained multi-task neural network model for correcting perspective distortion. In an embodiment, the instructions, when executed individually or collectively by the at least one processor, may cause the electronic device to output an image with corrected perspective distortion as the output image.

In an embodiment, a non-transitory computer readable medium having stored thereon a computer program comprising instructions which, when executed by at least one processor of an electronic device, cause the electronic device to perform the method, may be provided.

It will be clear to ones skilled in the art that the inventive concept is not limited to the aspects as outlined above, and the invention may take the form of other subject matters, such as a device, a system, a computer program, or a computer program product. Additional features will be apparent for persons skilled in the art from the detailed description of embodiments provided below.

### BRIEF DESCRIPTION OF THE DRAWINGS

Drawings are provided in this document to facilitate the understanding of the essence of certain example embodiments. Drawings are schematic and not drawn to scale. The drawings are for illustrative purposes only and are not intended to define the scope of certain example embodiments.

FIG. 1 shows a representative flowchart of the method according to an embodiment of the present disclosure;

FIG. 2 shows a representative system block diagram of an exemplary hardware implementation according to an embodiment of the present disclosure;

FIG. 3 shows a representative system block diagram of an architecture of multi-task neural network model according to an embodiment of the present disclosure;

FIG. 4 (views A and B), or FIGS. 4A and 4B, schematically illustrate(s) an example connection between the camera angle of view and the perspective distortion of a face image;

FIG. 5 schematically illustrates example segmentation and blending operations of an example multi-task end-to-end machine learning model in more details;

FIG. 6 schematically illustrates main image transformations in an example process of implementation according to an embodiment of the present disclosure;

FIGS. 7-9 illustrate example qualitative comparison of perspective distortion correction and novel view synthesis methods on known CMDP dataset and simple and complex cases of a dedicated test dataset specially generated for testing an example technique, respectively.

FIG. 10 shows a flowchart illustrating a method for correcting perspective distortion in an input image, according to an embodiment of the present disclosure.

FIG. 11 shows a flowchart illustrating a method for generating a dataset for training a multi-task neural network model, according to an embodiment of the present disclosure.

FIG. 12 shows a flowchart illustrating a method for training a multi-task neural network model for correcting perspective distortion in a digital image, according to an embodiment of the present disclosure.

FIG. 13 shows a block diagram illustrating an electronic device according to an embodiment of the present disclosure.

### DETAILED DESCRIPTION

Despite progress in developing approaches to predicting human portrait images with corrected perspective distortion, there are still certain limitations in the state-of-the-art approaches, one of which consists in reliance on optimization stages during inference, which poses challenges for practical applications, or reliance only on restored or warped results, which leads to identity loss or poor image fidelity. Furthermore, one of the most widely used benchmarks for evaluating perspective distortion correction, Caltech Multi-Distance Portraits (CMDP), introduces varying conditions and unnecessary noise that complicate comparisons between different methods. These may be regarded as drawbacks and objective technical problems to be solved.

An embodiment may provide a technique that performs perspective distortion correction of human portraits at least by obtaining a portrait of a person in any lightning conditions, facial expressions, sex and age, as input and outputting a predicted portrait with without perspective distortion, or with less perspective distortion.

The technical result improves quality of predicting human portrait images with corrected perspective distortion.

Exemplary embodiments of the present disclosure are described in detail below. The exemplary embodiments are illustrated in the appended drawings, where same or similar reference numerals may designate the same or similar elements, or elements which have the same or similar functions. Exemplary embodiments described with reference to the appended drawings are illustrative and are only used for explaining the present disclosure and should not be regarded as any restrictions thereto.

An embodiment may perform the functions of correcting perspective distortion of human portraits. It can be trained on a computer with Graphical Processing Units (GPUs) and inferenced on mobile devices and computers.

An embodiment of the present disclosure may address the limitations of the related art by proposing a novel approach for perspective distortion correction that eliminates the need for optimization at inference time. An embodiment may maintain original image details and preserve image fidelity by blending a warping image and a restored image.

An example approach is based upon a single multi-task end-to-end model that reduces (e.g., removes) perspective distortion without optimization.

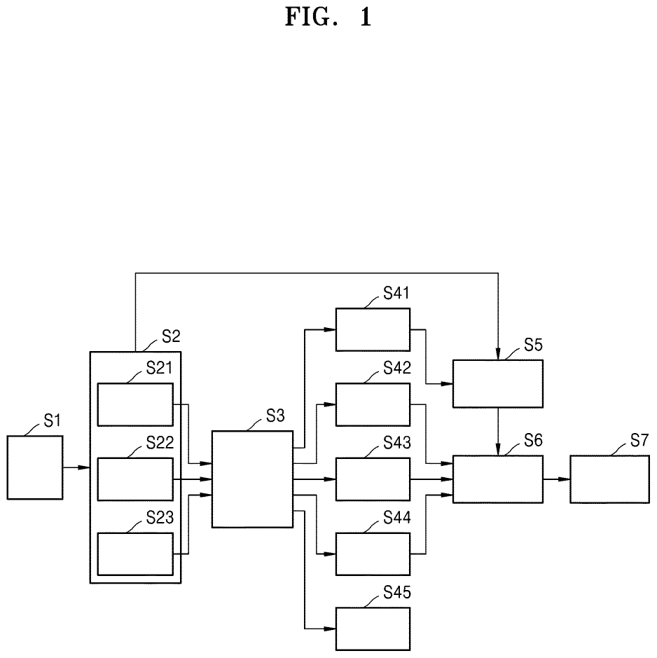

In the first part, an example method may involve a novel multi-task end-to-end machine learning model architecture for the task of perspective distortion correction (see FIG. 1). An example architecture may take an input image with perspective distortion, input angle and output angle. The input angle may specify how much distortion is present in the input image. The output angle may specify how much distortion should be present in the output image. Then, the input image, the input angle, and the output angle may be passed to a backbone model which outputs shared features that are passed to prediction heads. Each prediction head may predict a corresponding output.

In an embodiment, the input image and a warping field may be passed into an image warping operation to get a warped image. This method preserves a lot of high-frequency details but cannot restore missing facial features.

In an embodiment, a restoration head may generate a restored image by predicting an image in which the perspective distortion is eliminated. In this disclosure, the phrase “eliminating the perspective distortion” is not limited to a complete removal of the perspective distortion, but encompasses reducing the perspective distortion based on an output angle. This method may restore missing facial features but lacks high-frequency details.

Then, segmentation and blending operations may be performed, and the warped image and the restored image may be combined to get the best from both of them. This results in an output image without perspective distortion. Herein, the phrase “without perspective distortion” may include having a reduced amount of perspective distortion corresponding to the output angle.

The multi-task architecture and the way the outputs of its parts (predictive “heads”) are combined are novel. Related art methods require time-consuming optimization for each image. This limits practical applications, in particular, in mobile devices. The proposed inventive technique does not require optimization and has superior visual quality compared to related art methods.

Another part of an example technique is that a novel end-to-end predictive machine learning model training procedure on synthetic data is proposed. To successfully train machine learning model, such as a neural network, to perform perspective distortion correction, it is crucial that the only change between input and output training images comes from perspective distortion. There are no existing public datasets that have this property. They either contain additional noise (e.g., change in facial expression, lightning conditions, head pose) or they are too small. In an embodiment, a novel method of training models for the current task may be provided.

### TERMS AND DEFINITIONS

Prior to describing an example embodiment in detail, the following main terms as used throughout the present disclosure and in the appended claims will now be defined. It should be noted, however, that, unless specifically defined herein, all terms and notions should be construed in the same manner as commonly understood basing on the related art.

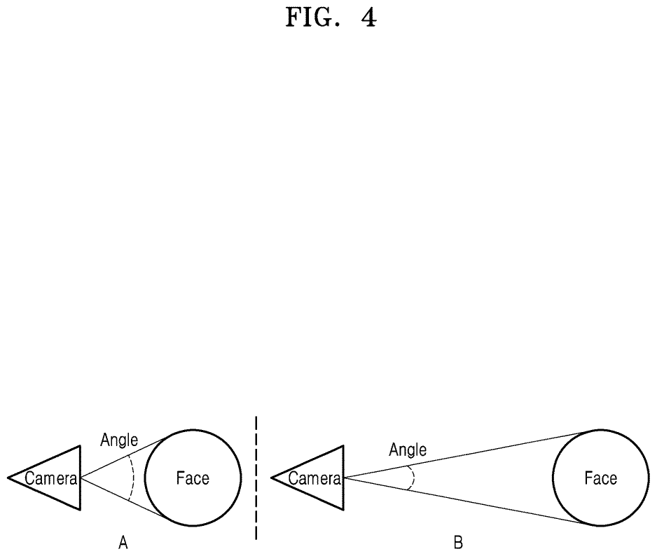

Angle: an angle between two rays originating from a camera's optical center and passing through the leftmost and rightmost points on the face within the scene, which characterizes an estimated amount of perspective distortion present in an image (see e.g. FIG. 4).

Input image: an image taken by a device, such as an AI controlled camera of an electronic apparatus or device, which has perspective distortion and is characterized by an input angle.

Input angle: specifies, for the input image, how much distortion is present in the input image.

Output angle: specifies, for the output image, how much distortion should be present in the output image.

Multi-task neural network model (also referred to herein as a multi-task machine learning model, end-to-end model etc.): machine learning model or algorithm which is used to generate the output image. The multi-task neural network model may predict shared features that are used by each of further prediction models (heads) for processing the input image so as to obtain an output image.

Output image: a resulting image output by an embodiment after correcting perspective distortion of the input image by means of an example multi-task neural network model.

Canonical image: an image resulting from processing the input image, in particular, but not limited to, by at least one of putting the face to a predefined position within the image, adjusting a rotation of the face (e.g., removing face rotation), or scaling the face to a predefined scale.

Restored image: an image without perspective distortion predicted by a Restoration Head (model). The restoration head may predict missing or occluded facial features to generate the restored image.

Warping Field: for each pixel in an image, encodes displacements (Δx, Δy) along X and Y axis. The effect of applying it to an image is that each pixel changes its position within the image according to the displacements.

Blend Mask: for each pixel in an image, encodes linear interpolation coefficient in the range [0, 1]. The blend mask may be used to perform linear interpolation of pixel values of warped and restored images.

The above-mentioned definitions should be regarded as an aid for a reader in understanding the essence of the present disclosure, and not as restricting or defining its scope. Having thus defined the key terms, we will now turn to the description of exemplary implementations of certain example embodiments and non-limiting use cases thereof.

### Exemplary Use Case

Now the operation of an example technique will be explained in detail on a non-limiting example, which should not be construed as restricting or defining the scope of the invention, neither is it intended to mean that all details described in this non-limiting example should define the invention in each and every embodiment.

In this particular implementation example, an example method may be implemented in an electronic apparatus or device equipped with a camera (such as, in particular, an AI or AI controlled camera). A non-limiting example of such apparatus or device may be e.g. a smartphone (such as a Samsung smartphone), a tablet computer, a laptop and/or a desktop computer, or any other electronic device of a similar kind equipped with a camera which is capable of taking a digital image, such as a human portrait image of a user.

Here, an example method for correcting perspective distortion in a digital image such as e.g. a human portrait image, which occurs during close-up shooting of a person's image (e.g. a user of the electronic device or apparatus taking a “selfie” image or e.g. participating in a video conference call, or the like), may include the following operations, as illustrated, in particular, in FIG. 1. It should be noted that all further description will concentrate on the case where the digital image in question is a human portrait image, although persons skilled in the art shall understand that the present disclosure is not restricted to this case, and certain other cases of image processing may also be conceived by those skilled in the art after carefully reading the present disclosure.

Turning now to FIG. 1, a method for correcting perspective distortion in a digital image may comprise the following main operations.

At operation S1 in FIG. 1, an input image, such as an RGB image taken by a camera of the electronic apparatus or device, may be input.

At operation S2, the input image may be preprocessed. The preprocessing may include at least the following operations. At operation S21, a canonical image may be obtained based on the input image using an image canonization procedure which will be described in more detail hereinbelow and which may, in general, include at least one of converting the input image into a canonical (standardized) image by putting the face to a predefined position within the image, adjusting a rotation of the face (e.g., removing face rotation), or scaling the face to a predefined scale. At operation S22, an input angle may be obtained based on the input image. At operation S23, an output angle may be obtained, which specifies, how much distortion should be present in the output image. For both input and output angles, it should be understood that an angle in this context may correspond to an angle between two rays originating from a camera's optical center and passing through the leftmost and rightmost points on the face within the scene, which characterizes an estimated amount of perspective distortion present in an image (see e.g. FIG. 4).

Then, at operation S3, the data from S2, e.g., the canonical image, the input angle and the output angle, may be used as inputs into a multi-task neural network model (also referred to herein as a multi-task end-to-end model).

At operation S41, the multi-task neural network model may obtain and generate a warping field based on the canonical image.

At operation S42, a restored image may be generated by the multi-task neural network model based on the canonical image, the input angle and the output angle.

At operation S43, a segmentation mask may be generated based on the above-mentioned inputs to the multi-task neural network model.

At operation S44, a blend mask may be generated based on the above-mentioned inputs to the multi-task neural network model.

At operation S45, a depth image may be generated based on the above-mentioned inputs to the multi-task neural network model. Note that operation S45 may be optional for certain particular embodiments, as the depth image generated at this operation may not be always used to obtain the resulting output image, but may be used in the course of multi-task neural network model training.

Next, at operation S5, image warping may be carried out, taking as input the canonical image and the warping field obtained at operation S41 above. The warping field may specify per-pixel displacements for the input (canonical) image and may be used to remove perspective distortion by image warping.

Then, at operation S6, image segmentation and blending may be performed, taking as input the warped image resulting from operation S5, the restored image from operation S42, the segmentation mask from operation S43, the blend mask from operation S44.

Eventually, at operation S7, the image resulting from the preceding operation S6 may be output as the output image without perspective distortions.

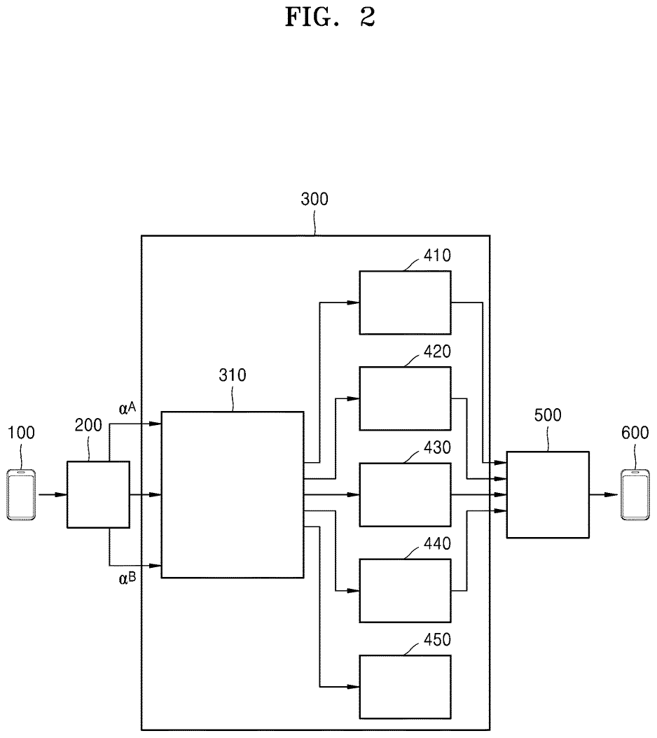

Turning now to FIG. 2, where a schematic block diagram represents the main modules (e.g., units, blocks, certain ones of them also being referred to herein as “heads”) of the apparatus or system which implements an embodiment of the present disclosure, it should first be noted that, typically, an embodiment may be implemented in an apparatus or device (such as e.g. a smartphone, a tablet computer, a laptop, a notebook, a desktop or any other similar computing device) equipped with a camera, such as e.g. an AI controlled camera for capturing digital images, and a processor, such as a general purpose processor (CPU) and/or a graphics processing unit (GPU). In general, the processing as described herein (including running the multi-task neural network model(s) etc.) may be performed, by way of a non-limiting example, on the basis of a server, a desktop, and/or a mobile device with a GPU.

In FIG. 2, camera 100 may capture at least one digital image, such as a portrait image of a person (e.g. the user of the apparatus or device), which is further referred to herein as “input image” (such as input image I^{A} which has perspective distortions).

The CPU/GPU, which implements one or more modules, units and/or “heads” as discussed immediately below, may receive the input image with perspective distortions from the camera 100. Image preprocessing module 200 may receive the input image and performs input image processing to generate a canonized (canonical) image I^{C}, to obtain an input angle α^{A} and output angle α^{B}. The way the input angle and the output angle may be obtained does not limit the scope of an embodiment, as persons skilled in the art may find it apparent to obtain these values using a wide scope of different means and methods. In particular, input angle may be obtained via image analysis based on image metadata such as lens profile characteristics, focal length etc., whereas output angle may be predefined for one or more image post-processing presets applied at a user's choice, or may be e.g. adjusted manually by a user via the respective graphical user interface (GUI) based on the user's preferences. “Based on” as used herein covers based at least on.

The canonical (canonized) image form may ensure that: i) the face of the person is centered around a target position within the image, ii) the scale of the face is the same across all people, iii) any rotation of the head is removed, so that all heads appear in a horizontal position. By way of a non-limiting example, the image preprocessing module 200 may apply a MODNet approach to separate the bust of a person in the input image I^{A}, which generally comprises the person's head, hair and upper torso. Then, MediaPipe algorithm may be used in the image preprocessing module 200 to detect eye positions and the bounding box of the face. Then, the current position, rotation and scale of the face may be computed, and an affine transformation may be applied that warps the bust into its canonical position. By way of a non-limiting example, the resulting canonical image I^{C} may have the shape of 3×512×512.

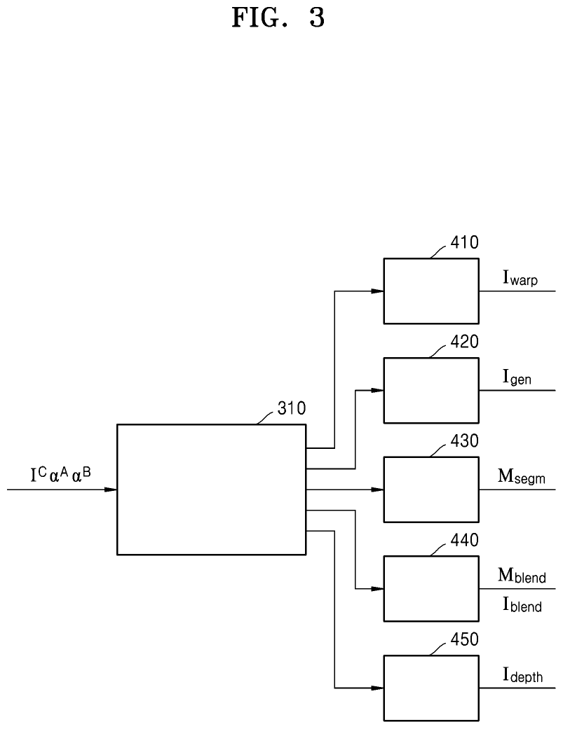

Image preprocessing module 200 may output the canonical image I^{C}, input angle α^{A} and output angle α^{B} to the multi-task neural network model unit 300, which is a core unit of the processing pipeline of an embodiment. As schematically shown in FIG. 3, the multi-task neural network model unit 300 may comprise a backbone model unit 310 as well as a warping head 410, restoration head 420, blend mask head 430, segmentation head 440, and depth head 450.

The multi-task neural network model unit 300 may receive, as inputs, the canonical image I^{C}, input angle α^{A} and output angle α^{B}, and may carry out the processing by means of a pre-trained multi-task neural network model, which will be described in detail hereinbelow along with its training process and generation of a unique training dataset of image pairs for the training of the multi-task neural network model.

In particular, the backbone model unit 310 may predict shared features that are used by each of the five prediction heads 410-450. In particular, the multi-task neural network model may perform prediction based on the canonical image in order to obtain a warping field, a restored image, a segmentation mask, and a blend mask. In general, it may be noted that the multi-task neural network model may substantially predict a warping field, missing or occluded facial features, a segmentation mask, a blend mask and depth estimation without optimization in one single operation.

Then, with continued reference to FIG. 2, the results of prediction of the multi-task neural network model unit 300 may be output to the target image synthesis unit 500, which is configured to synthesize the target image (e.g., the output image without perspective distortion I^{B} as discussed herein) using, as input, the predicted warping field, missing facial features, the segmentation mask, the blend mask and the depth mask. In particular, the target image synthesis unit 500 may warp the canonical image based on the predicted warping field to obtain a warped image, and generates an output image with corrected perspective distortion of the input image based on the warped image, the restored image, the segmentation mask, and the blend mask.

As mentioned above, the backbone model 310 of FIG. 3 may predict shared features that are used by each of the five prediction heads. The shared features may be a set of data which are predicted by the multi-task network model and are provided to each of the “heads” described herein, based on which each of the predictive “heads” predicts the respective different aspects of the same image. Taking the shared features as input, in particular, the warping head 410 may predict a warping field that specifies per-pixel displacements for the input image (or the canonical image). The warping field may be then used to remove perspective distortion by image warping as aforementioned. The restoration head 420 may predict missing or occluded facial features that are hidden in the input image due to the perspective distortion. The blend mask head 430 may predict per-pixel blending coefficients. These coefficients may be then used to combine the warped image and the restored image. The segmentation head 440 may predict a segmentation mask that is used to remove background from the warped image and the restored image. And the depth head 450 may predict a per-pixel depth-estimation mask.

Ones skilled in the art will appreciate that the technique may involve a multi-task neural network model as described hereinabove and schematically depicted in FIGS. 2 and 3, which receives, as input, an image (input image), e.g. taken by a camera of the electronic apparatus, in particular a portrait image (“selfie”) taken by a user of the electronic apparatus using the camera of the electronic apparatus, an input angle α^{A} and output angle α^{B}. “Angle” in the present context may correspond to the estimated amount of perspective distortion present in an image. Large angles correspond to large perspective distortion and vice versa. More formally, turning to views A and B in FIG. 4, “angle” may correspond to the angle between two rays originating from the camera's optical center and passing through the leftmost and rightmost points on the face within the scene.

### Multi-Task End-to-End Predictive Machine Learning Model Architecture

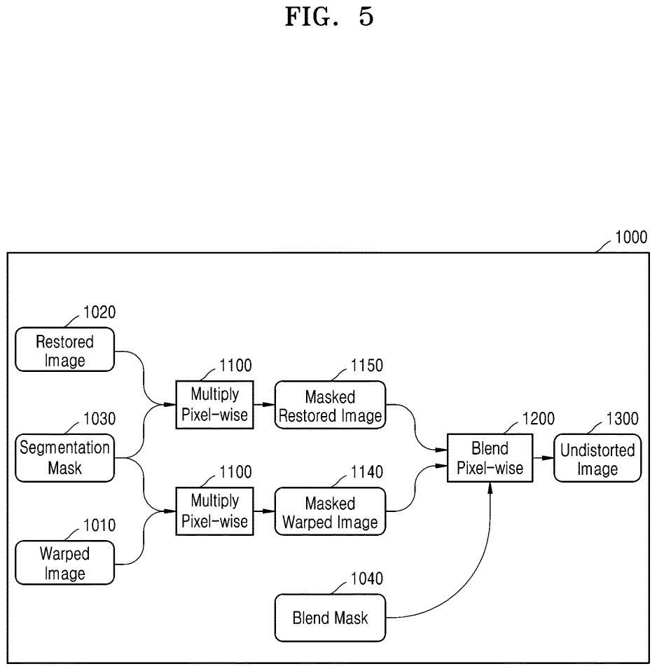

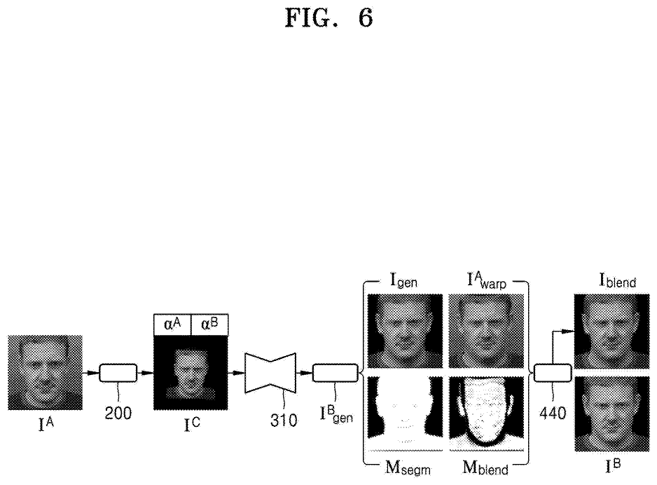

The machine learning model (also referred to herein as a multi-task neural network model) used in an embodiment generally may include or consist essentially of a backbone model, a warping head, a restoration head, a segmentation head, and a blend mask head. Besides the aforementioned, a final blending stage may also be applied. The operation of the multi-task end-to-end predictive machine learning model is illustrated in FIG. 5 with a detailed emphasis on segmentation and blending operations of a multi-task end-to-end machine learning model; and FIG. 6 schematically illustrates main image transformations in the process of implementation of a multi-task neural network model.

It is noted that, referring to FIG. 5, the processing pipeline 1000 according to an embodiment is as follows. Restored image (reference numeral 1020) and segmentation mask (reference numeral 1030) may be multiplied pixel-wise (reference numeral 1100) to obtain a masked restored image 1150, and the segmentation mask 1030 and a warped image (reference numeral 1010) may be multiplied pixel-wise (reference numeral 1100) to obtain a masked warped image 1140. The masked restored image 1150, the masked warped image 1140 may be blended pixel-wise (reference numeral 1200) based on a blend mask (reference numeral 1040) to obtain an undistorted image (reference numeral 1300). Having thus described the essence of the operations in terms of per-pixel operations, we will now turn to the details of implementation of these operations by the respective components of the multi-task end-to-end machine learning model of an embodiment.

In an embodiment, the backbone (shown as e.g. the backbone model 310 above) of the machine learning model may be based on a U-Net architecture that involves a sequence of downsampling and upsampling layers. As an alternative, however, other architectures may be used, such as e.g. an Autoencoder or a Transformer architecture, so certain example embodiments are not limited to using a U-Net architecture as the backbone of the machine learning model. Input angle α^{A} and output angle α^{B} may be concatenated with the canonical image I^{c} in the channel dimension to get an input tensor of shape 5×512×512. Then, the latter may be passed into the backbone to obtain a tensor of shared features F used by all prediction heads.

The warping head may take the tensor of shared features F and may predict a warping field of per-pixel displacements ΔW^{c}. Before applying it to the input image, I^{A}, decanonization into the input image space may be performed in order to obtain the warping field ΔW^{A} in the input image space. Each pixel (x, y) in the input image I^{A} may get translated by a vector of (Δₓ, Δ_{y}) to produce a pixel (x′, y′) in the warped image I^{A}_{warp}. This effectively removes perspective distortion present in the input image. During training, decanonization of the warped image I^{A}_{warp} into the output image space may be performed and image I^{B}_{warp} is obtained.

The restoration head may take the tensor of shared features F and may generate a restored image I^{C}_{gen} which is free from perspective distortion. This allows a method to restore parts of the bust in the image that were missing or occluded (e.g. chin, ears, hair). During training, decanonization of the predicted image into the output image space may be performed to obtain image I^{B}_{gen}.

The segmentation head may take the tensor of shared features F and may output a segmentation mask M^{C}_{segm} that is used to separate the bust in predicted images from the background. During training, decanonization of the predicted segmentation mask into the output image space may be performed to obtain mask M^{B}_{segm}.

The Blend Mask head may take the tensor of shared features F and may output a blend mask M blend that specifies per-pixel blending coefficients. is the blend mask may be used to combine the warped image I_{warp} and the restored image I_{gen}. During training, decanonization of the predicted blend mask into the output image space may be performed to obtain mask M^{B}_{blend}.

The blending coefficients may be learnt without supervision, and coefficients may be only penalized by the hard surface loss regularization. This makes the coefficients to be either one or zero. Effectively, it forces the model to choose a pixel either from the warped image I_{warp} or from the restored image I_{gen}. This makes it possible to take advantage of both image-warping and image-generating methods.

Here it may be assumed that all operations are performed in the output image space, thus the superscripts will be dropped for clarity. Segmentation mask M_{segm} may be applied to both I_{gen} and I_{warp} to remove the background. Then, linear interpolation between them may be computed using blending coefficients to get the blended image I_{blend} as follows:

$${ℐ}_{gen}^{′} = {ℐ}_{gen} * {ℳ}_{segm} , \qquad ( 1 )$$

$${ℐ}_{warp}^{′} = {ℐ}_{warp} * {ℳ}_{segm} ,$$

$${ℐ}_{blend} = {ℐ}_{warp}^{′} * {ℳ}_{blend} + {ℐ}_{gen}^{′} * ( 1 - {ℳ}_{blend} )$$

### Multi-Task End-to-End Predictive Machine Learning Model Training

The machine learning model training process in accordance with an embodiment may generally comprise or consist of:
obtaining a data pair (A, B) from a synthetic dataset generated with the novel procedure mentioned above which will be described in more detail below;
preprocessing A to obtain a canonical image A;
passing the canonical image A, input angle and output angle to the multi-task end-to-end model;
predicting, by the multi-task end-to-end model, images I_{gen}, I_{depth}, I_{blend}, as well as maps M_{segm}, M_{blend};
computing L1, Perceptual (LPIPS), Dice, Hard Surface (HSL) and Scale-Invariant (SI Log) losses;
computing a final training loss as a weighted sum of the above-mentioned losses; and
computing gradient and update parameters of the multi-task end-to-end model.

The L1 and Perceptual losses are crucial. The Dice, HSL, and SI Log losses are complementary but optional. B_{segm} and B_{depth} can be computed from B

In more detail, the training makes use the following loss functions: LPIPS, L1, Dice and hard surface loss (HSL). The ground truth output segmentation mask is denoted as M and the masked ground truth output image is denoted as Y′. Then, individual losses may have the form:

$${ℒ}_{L 1} = L 1 ( {ℐ}_{gen}^{′} , {Y}^{′} ) + L 1 ( {ℐ}_{blend}^{′} , {Y}^{′} ) , \qquad ( 2 )$$

$${ℒ}_{Perc} = LPIPS ( {ℐ}_{gen}^{′} , {Y}^{′} ) + LPIPS ( {ℐ}_{blend}^{′} , {Y}^{′} ) ,$$

$${ℒ}_{Dice} = Dice ( {ℳ}_{segm} , M ) ,$$

$${ℒ}_{HSL} = HSL ( {ℳ}_{blend} )$$

$${ℒ}_{Depth} = SI Log ( {ℐ}_{depth}^{′} )$$

The final training loss may have the form of a weighted sum:

[symbol]

=λ_{L1}* [symbol] _{L1}+λ_{Perc}* [symbol] _{Perc}+λ_{HSL}* [symbol] _{HSL}+λ_{Dice}* [symbol] _{Dice} (3)
where λ_{L1}=100, λ_{Perc}=10, λ_{HSL}=2.0, λ_{Dice}=1.0. The training may be performed for 40 epochs with the Adam optimizer. For the first, 35 epochs, the learning rate of 4.1e⁻⁴ may be kept fixed. Then, the learning rate may be decreased linearly down to 1.7e⁻⁵. The batch size may be set to 8.

In one or more non-limiting practical exemplary implementations of an embodiment, the training of the multi-task end-to-end predictive machine learning model according to an embodiment may be performed on a single NVIDIA Geforce RTX 4090 24 Gb GPU. The backbone may have the U-Net architecture with 8 downsampling and 8 up-sampling modules with a single convolutional layer in each. BatchNormalization and LeakyReLU may be used in all layers. Each prediction head may have a similar U-Net architecture but with only 4 downsampling and 4 upsampling modules and much fewer channels. The model may be trained on RGB images generated from the Efficient geometry-aware 3d generative adversarial networks (EG3D) method at the 512×512 resolution in half-precision. Data characterizing the evaluated results of the multi-task machine learning model training procedure in this exemplary setting will be presented hereinbelow.

### Evaluation of the Multi-Task End-to-End Machine Learning Model Training Results

Starting from CMDP (Fried et al., 2016), the present inventors compared an approach of an example embodiment to seven related art methods: method from Fried et al. (2016), method from Ko et al. (2023), HFGI3D (Xie et al., 2023), GOAE (Yuan et al., 2023), TriPlaneNet (Bhattarai et al., 2024), DisCO (Wang et al., 2024), and SUPER (Karpikova et al., 2024).

To evaluate the method of Fried et al. and DisCO on CMDP, all related art methods were evaluated on 29 pairs downloaded from the DisCO project official website. For the method from Ko et al., only the target camera parameters were passed. Both source and target camera parameters for HFGI3D, GOAE, TriPlaneNet and SUPER were passed. For a method, the following values of the input and output angles of distortion were set: α^{A}=10.0, α^{B}=0.2 for CMDP, α^{A}=14.0, α^{B}=2.0 for the dedicated test dataset specifically generated for testing an embodiment, with the distance of 20 cm, α^{A}=10.5, α^{B}=2.0 for the dedicated test dataset with the distance of 40 cm, and α^{A}=9.0, α^{B}=2.0 for the dedicated test dataset with the distance of 60 cm. For faster evaluation, all models were quantitatively evaluated only on simple cases for the dedicated test dataset. Qualitative comparison for complex cases on said dedicated test dataset is also presented hereinbelow.

The following photometric errors were computed: PSNR, SSIM (Wang et al., 2004), and LPIPS (Zhang et al., 2018)—between the aligned predicted and their corresponding ground truth images. The alignment algorithm is the following: key-points are detected using mediapipe (Lugaresi et al., 2019), then the predicted image is warped using the OpenCV library such that the keypoints from this image match the keypoints from the ground truth. Then, the background is removed using MODNet (Ke et al., 2022). Finally, the predicted and target images are resized to 256×256.

Further, BiSeNet (Yu et al., 2018) was used to extract faces, resize the images to 256×256, face features were extracted from the predicted and target images using ArcFace (Deng et al., 2019), and the cosine similarity between the extracted features was calculated.

Finally, normalized L2 distance between the keypoints of the predicted and target images extracted by mediapipe was calculated following the same alignment algorithm as for PSNR, SSIM and LPIPS. Tables 1 and 2 below show the results of experimental quantitative comparison of example perspective distortion correction methods on CMDP and the dedicated test dataset, respectively. Here, as well as in all other Tables hereinbelow, a value shown in bold type is the best value for the metric, and an underlined value is the second best metric.

TABLE 1
Quantitative comparison of perspective distortion
correction methods on CMDP (Fried et al., 2016)

| Method | PSNR | SSIM | LPIPS | ID | LMK-E |
|---|---|---|---|---|---|
| Fried et al. (2016) | 16.3678 | 0.6467 | 0.2065 | 0.9147 | 0.1662 |
| Ko et al. (2023) | 15.8551 | 0.5644 | 0.2514 | 0.6732 | 0.1815 |
| HFGI3D (2023) | 14.6799 | 0.5720 | 0.2627 | 0.6653 | 0.1712 |
| GOAE (2023) | 15.9045 | 0.5871 | 0.2525 | 0.7152 | 0.1609 |
| TriPlaneNet (2024) | 15.8353 | 0.5907 | 0.2483 | 0.7530 | 0.1522 |
| DISCO (2024) | 18.6300 | 0.6914 | 0.1608 | 0.8721 | 0.1236 |
| SUPER (2024) | 17.8695 | 0.6929 | 0.1678 | 0.9264 | 0.1213 |
| PDC (example | 18.3059 | 0.7199 | 0.1570 | 0.9297 | 0.1093 |
| embodiment) | | | | | |

TABLE 2
Quantitative comparison of perspective distortion
correction methods on the dedicated test dataset

| Method | PSNR | SSIM | LPIPS | ID | LMK-E |
|---|---|---|---|---|---|
| Ko et al. (2023) | 17.0575 | 0.5949 | 0.2432 | 0.5847 | 0.2826 |
| HFGI3D (2023) | 17.1599 | 0.6325 | 0.1971 | 0.6351 | 0.1749 |
| GOAE (2023) | 18.0591 | 0.6386 | 0.2062 | 0.6062 | 0.1689 |
| TriPlaneNet (2024) | 18.3554 | 0.6540 | 0.1902 | 0.6985 | 0.1557 |
| DisCO (2024) | 19.6778 | 0.6847 | 0.1651 | 0.7088 | 0.1301 |
| SUPER (2024) | 18.6348 | 0.7186 | 0.1682 | 0.9208 | 0.1028 |
| PDC (example | 22.3603 | 0.7762 | 0.1015 | 0.9272 | 0.0938 |
| embodiment) | | | | | |

### Machine Learning Model Training Dataset Generation

In one aspect of an embodiment, a method for generating a dataset for training a multi-task neural network model may be also suggested, the dataset introducing pairs of distorted and undistorted images with diverse real-world variations in lighting, distance, and subject attributes, resulting in what is referred to herein as synthetic data, or a synthetic training dataset. The idea for training the machine learning model on synthetic data is novel. Related art methods generally use real scans of people, which is very expensive, and thus is limited in terms of the amount of data that can be collected. Synthetic data, on the other hand, is much cheaper and can be generated at scale. Besides camera parameters, a method may also have access to depth information for each image. This method of training provides superior visual quality as compared to related art methods as will be seen on experimental data hereinbelow.

Taken in general, the method may comprise generating a single training pair (A, B) of images, which, in its turn, comprises: receiving at least one digital portrait image of a person; sampling the person identity; sampling a camera position close to the person, wherein the at least one digital portrait image of the person taking from a short distance has perspective distortion; sampling a camera position from a large distance from the person, wherein the image taken from large distance does not have a perspective distortion; rendering an image (A) of the person from the camera position close to the person; and rendering an image (B) of the person from the camera position from the large distance.

An embodiment may make use of the EG3D method that can render images of heads of people from different camera positions. In this way, all conditions during images collection may be controlled. To generate a single training pair for the training of the machine learning model, the following operations may be performed:

1. Sample the identity of a person whose portrait is depicted in one or more images; this may be achieved by sampling a random vector from a normal distribution. By “sampling”, generating a sample from a random distribution is meant in this context. Identity vector may be sampled and fixed so that person on the images A and B is the same.

2. Sample camera position close to the person. Image taken from a short distance has perspective distortion. Here reference may be made to a virtual camera that is used in the EG3D method. The essence of the operation of sampling is generally the same as mentioned above.

3. Render an image of the person from the current camera position (A).

4. Move camera away from the person. Image taken from a large distance does not have a perspective distortion or has less perspective distortion than the image taken from a short distance. The movement of the virtual camera may be done via mathematical operations.

5. Render an image of the person from the current camera position (B).

Then, the machine learning model may be trained to translate image A into image B, effectively removing perspective distortion.

An example algorithm may also make use of a MODNet approach to separate the bust of a person in the input image I^{A}, which generally comprises the person's head, hair and upper torso. Then, MediaPipe may be used to detect eye positions and the bounding box of the face. After that, the current position, rotation and scale of the face may be computed, and an affine transformation may be applied that warps the bust into its canonical position. The resulting canonical image I^{C} may have the shape of 3×512×512. As the machine learning model operates in the canonical space, an inverse operation which is referred to herein as decanonization may be used, which translates the machine learning model's predictions from the canonical space to the input image space. To achieve that, the original position, rotation and scale of the face during canonization may be stored.

In a non-limiting example, to generate the training data, EG3D technique may be used that can render busts of people at different camera positions. This enables control of the camera position while keeping everything else fixed. For the training dataset, the crucial fact is that all the differences between input and output images are caused by perspective distortion.

First, a pair of input and output distortion angles from U [0.02, 15] may be sampled to generate a single pair of images. FIG. 4 (views A and B) schematically illustrates the connection between the camera angle of view and the perspective distortion of a face image. Angle values may be swapped if the output angle value is larger than the input angle value, since the output image should be less distorted for the perspective distortion correction. Using angles, 3D information may be distilled down to a 2D model.

Then, a latent vector z~N(0, 1) used to generate input and output samples to preserve identity may be sampled. For each identity, three yaw α^{yaw}~U[−0.25, 0.25] and pitch α^{pitch}~U[−0.45, 0.05] angles may be also sampled. Given the distortion angle α, the camera radius may be calculated as follows:

$${r}_{camera} = \frac{{l}_{face}}{2 tan \frac{α}{2}} + {w}_{face} , \qquad ( 4 )$$

where l_{face} and w_{face} represent the average head width in front-on and profile respectively. In an exemplary embodiment, l_{face} and w_{face} are set to 0.2. Then, the Field of View (FOV) angle may be computed as follows:

$${α}^{FOV} = 2 arc tan \frac{γ {l}_{face}}{{r}_{camera}} , \qquad ( 5 )$$

where γ is a multiplication constant representing what portion of a photo the face should take. In an exemplary embodiment, γ was set to 3.0. Finally, the intrinsics and extrinsics of the camera may be calculated, and the latent vector and camera parameters may be provided to EG3D to generate the image and a depth map. This may be done for each quad of (z, α^{yaw}, α^{pitch}, α^{A}) for input images and for each quad of (z, α^{yaw}, α^{pitch}, α^{B}) for output images.

In a non-limiting example, 9 pairs of input and output images may be generated for each identity seed with 13,000 seeds in the training set, 1,000 in the validation set and 100 in the testing set. After generating the dataset, the latter may be canonized as described above.

Tables 3, 4 provided hereinbelow show a quantitative comparison of perspective distortion correction and novel view synthesis methods on CMDP (Fried et al., 2016) and the dedicated test dataset, respectively. An example algorithm according to an example embodiment, also referred to in the Tables as “PDC”, shows superior performance on all metrics except PSNR in which it is slightly outperformed by DisCO (Wang et al., 2024) on CMDP.

An example technique successfully removes the perspective distortion indicated by low LPIPS and LML-E and high SSIM while preserving the identity details by blending the warped input image with the generated output indicated by the high ID metric. Moreover, an example method works in a feed-forward mode resulting in a much faster inference compared to optimization-based methods such as DisCO (Wang et al., 2024) and SUPER (Karpikova et al., 2024).

### Experimental Data

To evaluate the contribution of individual components of the machine learning model in an example perspective distortion correction technique, the present inventors have conducted an ablation study on the dedicated test dataset and CMDP dataset.

The following configurations were analyzed:
Restoration Head: the model predicts the restored image;
Warping Head: the model predicts the warping field that is then applied to the input image;
Blending: the model predicts the restored image, warping field and blend mask. The warped image and the restored image are then blended to produce the final result;
Blending+Segmentation: Extends the previous configuration by adding the segmentation head.
Blending+Segmentation+Depth: Extends the previous configuration by adding the depth head.

Results of an ablation experimental study of a method on CMDP and dedicated test datasets, respectively, are provided below in Tables 3 and 4.

TABLE 3
Ablation study of an example method
on CMDP (Fried et al., 2016)

| Method | PSNR | SSIM | LPIPS | ID | LMK-E |
|---|---|---|---|---|---|
| Restoration | 18.6411 | 0.7121 | 0.2055 | 0.8935 | 0.1158 |
| Warping | 18.6055 | 0.7138 | 0.1409 | 0.9265 | 0.1150 |
| Blending | | | | | |
| Blending + | 18.7803 | 0.7201 | 0.1478 | 0.9273 | 0.1102 |
| Segmentation | | | | | |
| Blending + | 18.7739 | 0.7215 | 0.1458 | 0.9333 | 0.1107 |
| Segmentation + | | | | | |
| Depth | | | | | |

Table 3 shows the results of the ablation study of a method on CMDP. Blending+Segmentation configuration achieved the highest PSNR and the lowest LMK-E, emphasizing its robustness to complex distortions. The addition of a depth head improves SSIM and ID similarity, validating its role in enhancing 3D consistency and identity preservation. The Warping Head, while optimal for LPIPS, underperformed in PSNR and ID preservation, highlighting a trade-off between geometric accuracy and texture fidelity in challenging cases.

TABLE 4
Ablation study of a method on the dedicated test dataset

| Method | PSNR | SSIM | LPIPS | ID | LMK-E |
|---|---|---|---|---|---|
| Restoration | 21.0840 | 0.7507 | 0.1487 | 0.9057 | 0.0969 |
| Warping | 22.4267 | 0.7707 | 0.0981 | 0.9255 | 0.0935 |
| Blending | | | | | |
| Blending + | 22.2903 | 0.7715 | 0.1076 | 0.9265 | 0.0902 |
| Segmentation | | | | | |
| Blending + | 22.2561 | 0.7723 | 0.1034 | 0.9264 | 0.0928 |
| Segmentation + | | | | | |
| Depth | | | | | |

Similarly, Table 4 shows the results of the ablation study of an example method on the dedicated test dataset. As in CMDP, the warping head significantly outperformed the Restoration Head in all metrics, demonstrating the importance of explicit geometric correction. The addition of blending regularized with segmentation task further improved ID and LMK-E, though with a marginal drop in PSNR compared to the Warping Head. Integrating depth constraints yielded the highest SSIM but introduced a slight trade-off in LMK-E, suggesting that depth aids structural fidelity at the cost of minor landmark alignment degradation.

### Quantitative Comparison Studies

Additional experimental data showing the quantitative comparison results of an example method with the closest related art approaches are provided below in Tables 5-7, which show the quantitative comparisons of perspective distortion correction and novel view synthesis methods on the dedicated test dataset with distance of 20 cm, 40 cm and 60 cm, respectively. It is shown that PDC (example embodiment) outperforms all other methods on all metrics except ID metric on 40 cm, on which it is outperformed by SUPER (Karpikova et al., 2024).

TABLE 5
Quantitative comparison of perspective distortion correction methods
on the dedicated test dataset for the distance of 20 cm

| Method | PSNR | SSIM | LPIPS | ID | LMK-E |
|---|---|---|---|---|---|
| Ko et al. (2023) | 15.3252 | 0.5382 | 0.2970 | 0.5288 | 0.3540 |
| HFGI3D (2023) | 15.3476 | 0.5692 | 0.2653 | 0.5525 | 0.2626 |
| GOAE (2023) | 15.7878 | 0.5757 | 0.2613 | 0.5529 | 0.2448 |
| TriPlaneNet (2024) | 16.0507 | 0.5912 | 0.2468 | 0.6309 | 0.2317 |
| DisCO (2024) | 19.5635 | 0.6853 | 0.1599 | 0.6753 | 0.1300 |
| SUPER (2024) | 16.9534 | 0.6670 | 0.1903 | 0.8790 | 0.1327 |
| PDC (example | 19.7191 | 0.7346 | 0.1316 | 0.8811 | 0.1159 |
| embodiment) | | | | | |

TABLE 6
Quantitative comparison of perspective distortion correction methods
on the dedicated test dataset for the distance of 40 cm

| Method | PSNR | SSIM | LPIPS | ID | LMK-E |
|---|---|---|---|---|---|
| Ko et al. (2023) | 17.4233 | 0.6051 | 0.2396 | 0.5947 | 0.2694 |
| HFGI3D (2023) | 17.4312 | 0.6402 | 0.1878 | 0.6518 | 0.1528 |
| GOAE (2023) | 18.7844 | 0.6563 | 0.1911 | 0.6347 | 0.1450 |
| TriPlaneNet (2024) | 18.6804 | 0.6625 | 0.1808 | 0.7355 | 0.1367 |
| DisCO (2024) | 20.5898 | 0.7011 | 0.1537 | 0.7299 | 0.1179 |
| SUPER (2024) | 19.8392 | 0.7502 | 0.1484 | 0.9407 | 0.0893 |
| PDC (example | 23.5687 | 0.7972 | 0.0876 | 0.9383 | 0.0863 |
| embodiment) | | | | | |

TABLE 7
Quantitative comparison of perspective distortion correction methods
on the dedicated test dataset for the distance of 60 cm

| Method | PSNR | SSIM | LPIPS | ID | LMK-E |
|---|---|---|---|---|---|
| Ko et al. (2023) | 18.2014 | 0.6342 | 0.2000 | 0.6234 | 0.2337 |
| HFGI3D (2023) | 18.4652 | 0.6799 | 0.1471 | 0.6903 | 0.1205 |
| GOAE (2023) | 19.3184 | 0.6759 | 0.1733 | 0.6246 | 0.1266 |
| TriPlaneNet (2024) | 20.0349 | 0.7001 | 0.1502 | 0.7210 | 0.1084 |
| DisCO (2024) | 18.8852 | 0.6681 | 0.1807 | 0.7173 | 0.1421 |
| SUPER (2024) | 18.9144 | 0.7324 | 0.1683 | 0.9377 | 0.0902 |
| PDC (example | 23.4677 | 0.7918 | 0.0891 | 0.9564 | 0.0821 |
| embodiment) | | | | | |

### Experimental Results of Qualitative Comparison Studies

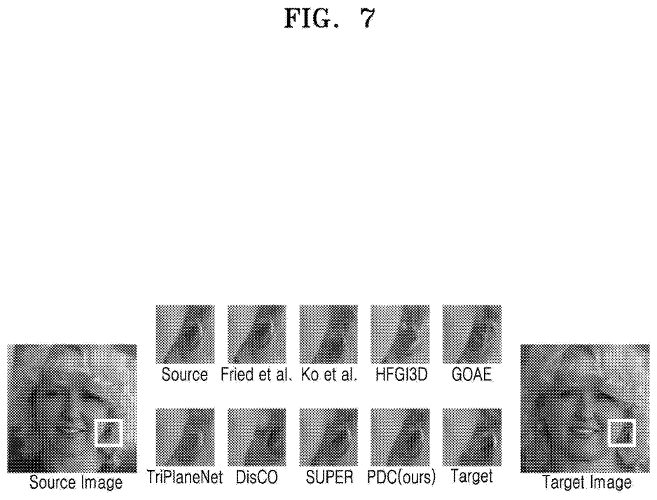

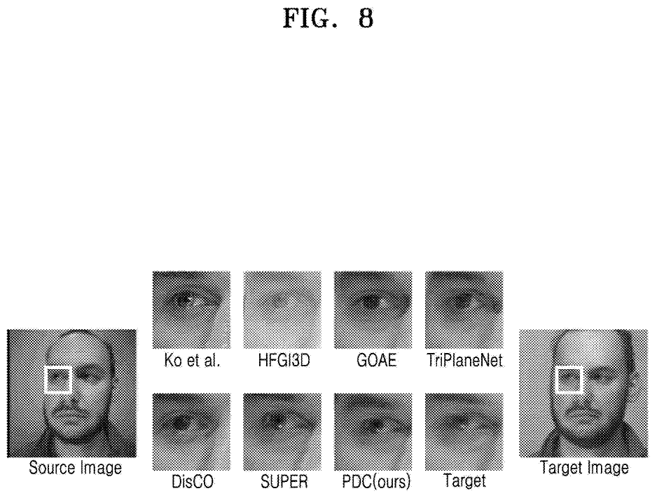

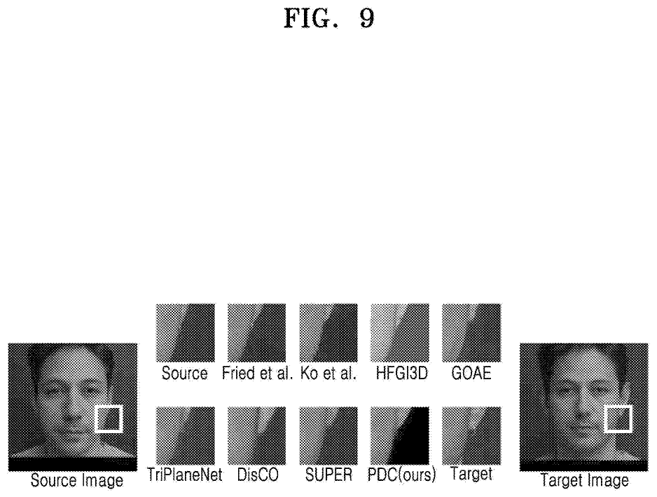

Experimental results illustrated in FIGS. 7-9 provide a qualitative comparison of perspective distortion correction and novel view synthesis methods on CMDP (Fried et al., 2016) and simple and complex cases of the dedicated test dataset, respectively.

It can be seen in FIGS. 7-9 that, although the related art approach of Fried et al. (2016) removes some perspective distortion from the source image, the results still have a significant level of perspective distortion compared to the target images, especially in the area of ears. The approaches by Ko et al. (2023), HFGI3D (Xie et al., 2023), GOAE (Yuan et al., 2023) and TriPlaneNet (Bhattarai et al., 2024) introduce only insignificant changes in terms of face distortion while losing identity details such as earrings, moles, eye colour and wrinkles. Moreover, these related art approaches fail to process accessories such as eye patch, and hands and fingers.

In contrast, DisCO (Wang et al., 2024) provided much better results, successfully removing perspective distortion. However, this related art approach still suffers from identity loss such as removed earrings (see e.g. FIG. 7, second row) since the results are fully generated.

SUPER (Karpikova et al., 2024) and an example technique successfully corrected the perspective distortion without losing identity details. However, an embodiment of the present disclosure has more practical applications since it does not require time-consuming optimization and works in a feed-forward regime.

### Alternative Embodiments

Since an example method, taken in general, may take the input image and angles of distortion (e.g., the input angle and the output angle) as input, in certain non-limiting embodiments it might incorrectly undistort some extreme cases, leading to undesired results. So, an embodiment may additionally benefit from conditioning the predictive model on yaw and pitch angles to solve this issue.

An example method, taken in general, may also incorrectly work with some rare accessories such as glasses with heart-shaped lenses, leading to incorrect warping. The reason is that EG3D was not trained on such images and hence cannot synthesize such complex images. Hence, in a non-limiting embodiment, a possible solution may be to implement a certain controlled generation EG3D to ensure that such complex accessories appear in the training set.

Finally, taken in general, an example algorithm may involve the input angle of distortion, which might be hard to obtain for real-world images.

An example feed-forward model may eliminate the need for optimization during inference and combines warping and generative techniques to produce high quality, natural-looking results while preserving identity. By conditioning on input angle and output angle and employing a multi-task machine end-to-end learning model architecture, an example algorithm has achieved high performance on both the CMDP benchmark and the dedicated test dataset.

Experimental data provided above has demonstrated the superiority of an example algorithm in preserving identity details and handling occlusions, with ablation studies confirming the effectiveness of an example blending strategy and segmentation integration.

Each embodiment herein may be used in combination with any other embodiment(s) described herein.

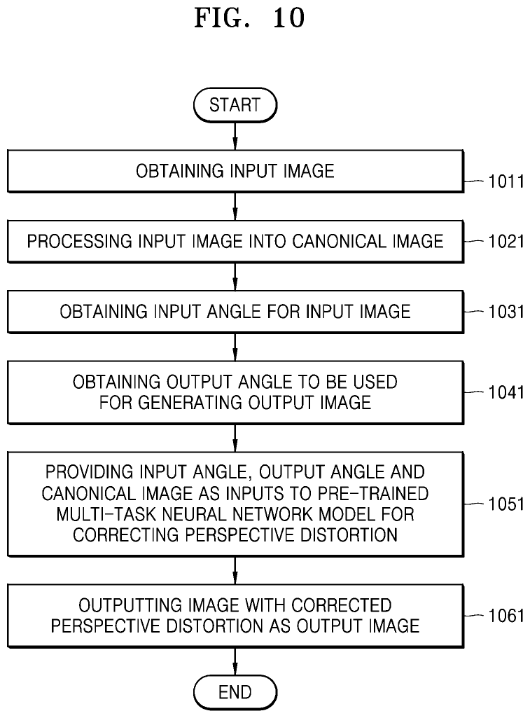

FIG. 10 shows a flowchart illustrating a method for correcting perspective distortion in an input image, according to an embodiment of the present disclosure.

In an embodiment, an electronic device may perform the method for correcting perspective distortion in an input image. In an embodiment, at operation 1011, the electronic device may obtain an input image. In an embodiment, at operation 1021, the electronic device may process the input image into at least a canonical image. In an embodiment, at operation 1031, the electronic device may obtain an input angle for the input image. In an embodiment, at operation 1041, the electronic device may obtain an output angle to be used for generating the output image. In an embodiment, at operation 1051, the electronic device may provide the input angle, the output angle and the canonical image as inputs to a pre-trained multi-task neural network model for correcting perspective distortion. In an embodiment, at operation 1061, the electronic device may output an image with corrected perspective distortion as the output image.

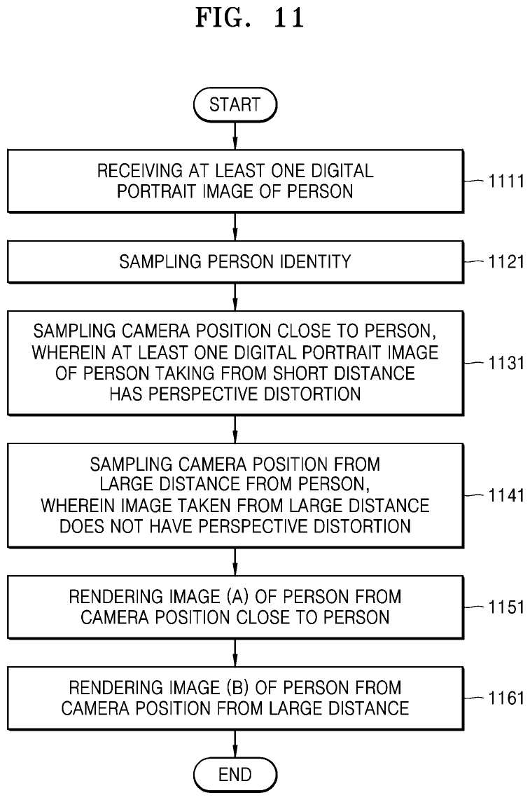

FIG. 11 shows a flowchart illustrating a method for generating a dataset for training a multi-task neural network model, according to an embodiment of the present disclosure.

In an embodiment, an electronic device may perform the method for generating a dataset for training a multi-task neural network model. In an embodiment, the electronic device may generate a training pair comprising a first image and a second image.

In an embodiment, at operation 1111, the electronic device may receive at least one digital portrait image of a person. In an embodiment, at operation 1121, the electronic device may sample a person identity. In an embodiment, at operation 1131, the electronic device may sample a camera position close to the person, wherein the at least one digital portrait image of the person taking from a short distance has perspective distortion. In an embodiment, at operation 1141, the electronic device may sample a camera position from a large distance from the person, wherein the image taken from large distance does not have a perspective distortion. In an embodiment, at operation 1151, the electronic device may render an image (A) of the person from the camera position close to the person. In an embodiment, at operation 1161, the electronic device may render an image (B) of the person from the camera position from the large distance.

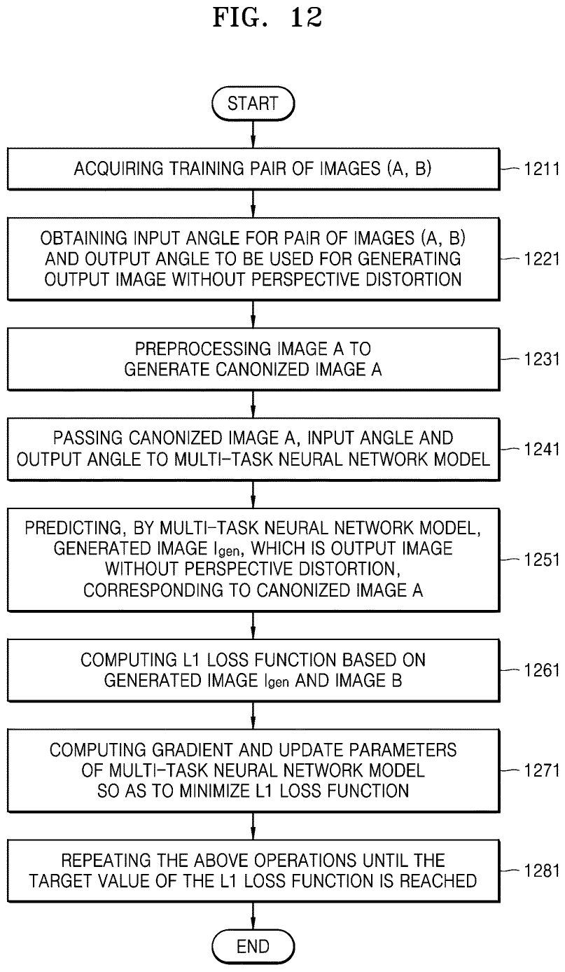

FIG. 12 shows a flowchart illustrating a method for training a multi-task neural network model for correcting perspective distortion in a digital image, according to an embodiment of the present disclosure.

In an embodiment, an electronic device may perform the method for training a multi-task neural network model for correcting perspective distortion in a digital image. In an embodiment, at operation 1211, the electronic device may acquire a training pair of images (A, B). In an embodiment, at operation 1221, the electronic device may obtain an input angle for the pair of images (A, B) and output angle to be used for generating the output image without perspective distortion. In an embodiment, at operation 1231, the electronic device may preprocess image A to generate a canonized image A. In an embodiment, at operation 1241, the electronic device may pass the canonized image A, input angle and output angle to a multi-task neural network model. In an embodiment, at operation 1251, the electronic device may predict, by the multi-task neural network model, a generated image I_{gen}, which is an output image without perspective distortion, corresponding to the canonized image A. In an embodiment, at operation 1261, the electronic device may compute a L1 loss function based on the generated image I_{gen} and the image B. In an embodiment, at operation 1271, the electronic device may compute gradient and update parameters of the multi-task neural network model so as to minimize the L1 loss function. In an embodiment, at operation 1281, the electronic device may repeat the above operations until the target value of the L1 loss function is reached.

### Hardware Implementation

In general, persons skilled in the art will appreciate that an embodiment of the present disclosure may be implemented in many various combinations of hardware and software means, depending on a given implementation scenario. As such, the proposed algorithm may be used in a computer or a mobile device. An example set of hardware components to implement an embodiment may include a storage device, such as at least one memory, and a processor(s) for processing information, such as at least one CPU or GPU or the like. A preferred set of hardware components for particular implementations which provide a faster inference time includes a storage device, a processor for processing information, and a graphics processor. The inventive machine learning model may be trained on a computer with Graphical Processing Units (GPUs) and inferenced on mobile devices and computers.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In a non-limiting embodiment, an example apparatus may involve a computational device that runs an example multi-task neural network model, as well as the further modules (“heads”) such as e.g. an image warping module, a segmentation module, a blending module, a depth module. The multi-task neural network model may receive, as input, a canonical image, an input angle, and an output angle, and provides, as output, an output image without perspective distortion. A warping field, a restored image, a segmentation mask, a blend mask, a depth image may also be output by the respective modules in a non-limiting embodiment. In particular, the image warping module may receive, as input, a canonical image, a warping field, and provides, as output, a warped image without perspective distortion. The segmentation and blending module may receive, as input, a restored image, a warped image, a segmentation mask, and a blend mask, and provides, as output, an undistorted image (e.g., an output image). A memory (separate, dedicated, or otherwise) may be configured to store at least the following types of images: a canonical image, a restored image, a warped image, and an undistorted image.

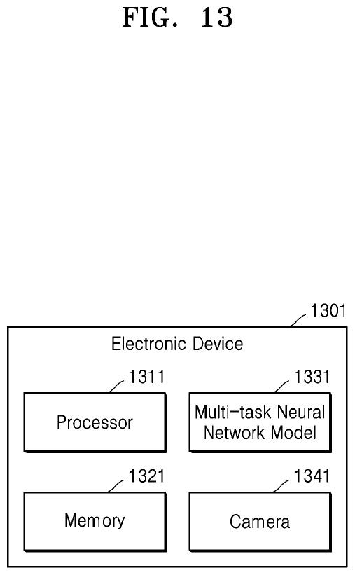

FIG. 13 shows a block diagram illustrating an electronic device according to an embodiment of the present disclosure.

In an embodiment, an electronic device 1301 may correct perspective distortion of an input image. In an embodiment, the electronic device 1301 may include at least one processor 1311, comprising processing circuitry, and memory 1321 storing instructions. The instructions, when executed individually or collectively by the at least one processor 1311, may cause the electronic device 1301 to correct perspective distortion of an input image.

In an embodiment, the electronic device 1301 may include a multi-task neural network model 1331. For example, the multi-task neural network model 1331 may include the multi-task neural network model unit 300 in FIG. 2. In an embodiment, the multi-task neural network model 1331 may be stored in the memory 1321. The electronic device 1301 may user the multi-task neural network model 1331 to correct perspective distortion of an input image.

In an embodiment, the electronic device 1301 may generate a dataset for training the multi-task neural network model 1331. In an embodiment, the electronic device 1301 may train the multi-task neural network model 1331.

In an embodiment, the electronic device 1301 may include a camera 1341. The electronic device 1301 may capture the input image using the camera 1341.

Persons skilled in the art shall understand that, in general, an example technique may be implemented by various combinations of hardware and software means, and any such particular combinations do not restrict the scope of the present disclosure. Any method operations and/or functional modules (“heads”) described above may be implemented in the form of any suitable combination of software and hardware means, whereas hardware may include separate hardware means, or two or more method operations and/or functional modules (“heads”) may be implemented by one hardware means, or the whole inventive algorithm may be implemented by one or more computer(s), processor(s) (CPUs) such as general purpose processors or specialized processors such as graphics processors (GPUs), or by one or more application-specific integrated circuit (ASICs), field-programmable gate array (FPGAs), logic elements etc. Alternatively, one or more method operations and/or functional modules and/or machine learning model “heads” may be implemented as software means such as e.g. a program or programs, computer program element(s) or module(s) which control one or more computer(s), CPUs etc. to implement the method operations and/or operations as described in detail above. These software means may be embodied in one or more computer-readable media which are well known to ones skilled in the art, may be stored in one or more memories such as a read-only memory (ROM), a random access memory (RAM), flash memory, electrically erasable programmable read-only memory (EEPROM), etc., or provided e.g. from remote servers via one or more wired and/or wireless network connections, the Internet, Ethernet connection, local area network (LAN(s)), or other local or global computer networks, if necessary.

### INDUSTRIAL APPLICABILITY

An embodiment may be used in a wide variety of hardware and software applications, which include, but are not limited to, image editing suites; applications performing visual analysis from portraits (e.g., person identification or verification); applications enabling video streaming (e.g., conference calls, video blogging). Taken in general, an embodiment may be useful in any application which may need perspective distortion correction of human portraits by taking a portrait of a person in any lightning conditions, facial expressions, sex and age, as input and outputs a portrait without perspective distortion, including, but not limited to, video conferencing, person identification/authentication/recognition, photo editing, computer vision, social networking etc.

Persons skilled in the art shall understand that only some of the possible examples of techniques and material and technical means by which embodiments of certain example embodiments may be implemented are described above and shown in the figures. Detailed description of an embodiment as provided above is not intended for limiting or defining the scope of legal protection.

Other embodiments which may be encompassed by the scope of the present disclosure may be conceived by persons skilled in the art after careful reading of the above specification with reference to the accompanying drawings, and all such apparent modifications, changes and/or equivalent substitutions are considered to be included in the scope of the present disclosure. All related art references cited and discussed herein are hereby incorporated in this disclosure by reference where applicable.

While an embodiment has been described and illustrated with reference to its different embodiments, persons skilled in the art shall understand that various modifications in its form and specific details may be made without departing from the scope of the present disclosure which is only defined by the claims provided hereinbelow and their equivalents.

A method, performed by an electronic device, for correcting perspective distortion in a digital image may be provided. The method may include obtaining an input image. The method may include processing the input image into a canonical image. The method may include obtaining an input angle for the input image. The method may include obtaining an output angle to be used for generating the output image. The method may include providing the input angle, the output angle and the canonical image as inputs to a pre-trained multi-task neural network model for correcting perspective distortion. The method may include outputting an image with corrected perspective distortion as the output image.

The method may include predicting, using a warping head of the pre-trained multi-task neural network model, a warping field indicating per-pixel displacement for eliminating the perspective distortion. The method may include performing image warping based on the warping field to obtain a warped image.

The method may include generating, using a restoration head of the pre-trained multi-task neural network model, a restored image, by predicting an image in which the perspective distortion is reduced.

The method may include generating, using a segmentation head of the pre-trained multi-task neural network model, a segmentation mask. The method may include applying the segmentation mask to the restored image and the warped image to remove background in the restored image and the warped image.

The method may include generating a blend mask using a blend mask head of the pre-trained multi-task neural network model, wherein the blend mask comprises coefficients indicating blending ratio between the restored image and the warped image.

The method may include blending, based on the blend mask, the restored image in which the background is removed and the warped image in which the background is removed.

The method may include detecting a face in the input image.

The processing the input image into the canonical image may include at least one of putting a face to a predefined position within the input image, adjusting a rotation of the face, or scaling the face to a predefined scale.

The pre-trained multi-task neural network model may include a warping head, a restoration head, a segmentation head, a blend mask head, and a depth head configured to predict per-pixel depth.

The predicting, using the warping head, the warping field may include obtaining a tensor of shared features F.

The tensor of shared features F may be used to generate a restored image using a restoration head, and to generate a blend mask using a blend mask head.

The blending the restored image in which the background is removed and the warped image in which the background is removed may include computing linear interpolation between the warped image in which the background is removed and the restored image in which the background is removed based on the coefficients comprised in the blend mask.

An electronic device for correcting perspective distortion in a digital image may be provided. The electronic device may include at least one processor, comprising processing circuitry, and memory storing instructions. The instructions, when executed individually or collectively by the at least one processor, may cause the electronic device to obtain an input image. The instructions, when executed individually or collectively by the at least one processor, may cause the electronic device to process the input image into at least a canonical image. The instructions, when executed individually or collectively by the at least one processor, may cause the electronic device to obtain an input angle for the input image. The instructions, when executed individually or collectively by the at least one processor, may cause the electronic device to obtain an output angle to be used for generating the output image. The instructions, when executed individually or collectively by the at least one processor, may cause the electronic device to provide the input angle, the output angle and the canonical image as inputs to a pre-trained multi-task neural network model for correcting perspective distortion. The instructions, when executed individually or collectively by the at least one processor, may cause the electronic device to output an image with corrected perspective distortion as the output image.

The instructions, when executed individually or collectively by the at least one processor, may cause the electronic device to predict, using a warping head of the pre-trained multi-task neural network model, a warping field indicating per-pixel displacement for eliminating the perspective distortion. The instructions, when executed individually or collectively by the at least one processor, may cause the electronic device to perform image warping based on the warping field to obtain a warped image.

The instructions, when executed individually or collectively by the at least one processor, may cause the electronic device to generate, using a restoration head of the pre-trained multi-task neural network model, a restored image, by predicting an image in which the perspective distortion is reduced.

The instructions, when executed individually or collectively by the at least one processor, may cause the electronic device to generate, using a segmentation head of the pre-trained multi-task neural network model, a segmentation mask. The instructions, when executed individually or collectively by the at least one processor, may cause the electronic device to apply the segmentation mask to the restored image and the warped image to remove background in the restored image and the warped image.

The instructions, when executed individually or collectively by the at least one processor, may cause the electronic device to generate a blend mask using a blend mask head of the pre-trained multi-task neural network model, wherein the blend mask comprises coefficients indicating blending ratio between the restored image and the warped image.

The instructions, when executed individually or collectively by the at least one processor, may cause the electronic device to blend, based on the blend mask, the restored image in which the background is removed and the warped image in which the background is removed.

The instructions, when executed individually or collectively by the at least one processor, may cause the electronic device to detect a face in the input image.

The instructions, when executed individually or collectively by the at least one processor, may cause the electronic device to perform at least one of putting a face to a predefined position within the input image, adjusting a rotation of the face, or scaling the face to a predefined scale.

The instructions, when executed individually or collectively by the at least one processor, may cause the electronic device to obtain a tensor of shared features F.

The instructions, when executed individually or collectively by the at least one processor, may cause the electronic device to compute linear interpolation between the warped image in which the background is removed and the restored image in which the background is removed based on the coefficients comprised in the blend mask.

The pre-trained multi-task neural network model may have an architecture which comprises a backbone model conditioned with the input angle and the output angle. The architecture may include one or more of: a warping head configured to generate a warping field indicating per-pixel displacement that removes perspective distortion when applied to the input image, a restoration head configured to generate a restored image using a tensor of shared features F, a segmentation head configured to generate a segmentation mask that is used to remove background from the restored image and a warped image, a blend mask head configured to generate a blend mask that combines the warped image and the restored image into a blended image, or a depth head configured to predict a depth map of the restored image.

A computer readable medium having stored thereon a computer program comprising instructions which, when executed by at least one processor of an electronic device, cause the electronic device to perform the method, may be provided.

A method for generating a dataset for training a multi-task neural network model, said dataset introducing pairs of distorted and undistorted images with diverse real-world variations in lighting, distance, and subject attributes may be provided. The method may include generating a single training pair (A, B) of images. The method may include receiving at least one digital portrait image of a person. The method may include sampling a person identity. The method may include sampling a camera position close to the person, wherein the at least one digital portrait image of the person taking from a short distance has perspective distortion. The method may include sampling a camera position from a large distance from the person, wherein the image taken from large distance does not have a perspective distortion. The method may include rendering an image (A) of the person from the camera position close to the person. The method may include rendering an image (B) of the person from the camera position from the large distance.

In an embodiment, a method of training a multi-task neural network model for correcting perspective distortion in a digital image may be provided. The method may include acquiring a training pair of images (A, B). The method may include obtaining an input angle for the pair of images (A, B) and output angle to be used for generating the output image without perspective distortion. The method may include preprocessing image A to generate a canonized image A. The method may include passing the canonized image A, input angle and output angle to a multi-task neural network model. The method may include predicting, by the multi-task neural network model, a generated image I_{gen}, which is an output image without perspective distortion, corresponding to the canonized image A. The method may include computing a L1 loss function based on the generated image I_{gen} and the image B. The method may include computing gradient and update parameters of the multi-task neural network model so as to minimize the L1 loss function. The method may include repeating the above steps until the target value of the L1 loss function is reached.

The method may include generating a depth image I_{depth}, a blended image I_{blend}, a segmentation mask M_{segm}, and a blend mask M_{blend}.

The method may include computing one or more of a perceptual loss (LPIPS) function, Dice loss function, hard surface loss (HSL) function, and scale-invariant (SI Log) loss function. The method may include computing a final training loss based on a weighted sum of the L1 loss function and said one or more computed loss functions.

The method may include obtaining a tensor of shared features F at least by concatenating the input angle and the output angle with the canonized image A.

The method may include predicting a warping field of per-pixel displacements based on the tensor of shared features F.

The generated image I_{gen} may be generated based on the tensor of shared features F.

### CITATIONS LIST

Bhattarai, A. R., Nießner, M., and Sevastopolsky, A. Triplanenet: An encoder for eg3d inversion. In Proceedings of the IEEE/CVF Winter Conference on Applications of Computer Vision (WACV), pp. 3055-365 January 2024.
Chan, E. R., Lin, C. Z., Chan, M. A., Nagano, K., Pan, B., De Mello, S., Gallo, O., Guibas, L. J., Tremblay, J., Khamis, S., Karras, T., and Wetzstein, G. Efficient geometry-aware 3d generative adversarial networks. In Proceedings of the IEEE/CVF Conference on Computer Vision and Pattern Recognition (CVPR), pp. 16123-16133, June 2022.
Deng, J., Guo, J., Xue, N., and Zafeiriou, S. Arcface: Additive angular margin loss for deep face recognition. In Proceedings of the IEEE/CVF Conference on Computer Vision and Pattern Recognition (CVPR), June 2019.
Fried, O., Shechtman, E., Goldman, D. B., and Finkelstein, A. Perspective-aware manipulation of portrait photos. ACM Trans. Graph., 35(4), July 2016. ISSN 0730-0301. doi: 10.1145/2897824.2925933.
Karpikova, P., Spiridonov, A., Vorontsova, A., Yaschenko, A., Radionova, E., Medvedev, I., and Limonov, A. Super: Selfie undistortion and head pose editing with identity preservation. In 2024 IEEE International Conference on Image Processing (ICIP), pp. 1704-1710, 2024. doi: 10.1109/ICIP51287.2024.10647926.
Ke, Z., Sun, J., Li, K., Yan, Q., and Lau, R. W. Modnet: Real-time trimap-free portrait matting via objective decomposition. Proceedings of the AAAI Conference on Artificial Intelligence, 36(1):1140-1147 June 2022. doi: 10.1609/aaai.v36i1.19999.
Ko, J., Cho, K., Choi, D., Ryoo, K., and Kim, S. 3d gan inversion with pose optimization. In Proceedings of the IEEE/CVF Winter Conference on Applications of Computer Vision (WACV), pp. 2967-2976 January 2023.
Lugaresi, C., Tang, J., Nash, H., McClanahan, C., Uboweja, E., Hays, M., Zhang, F., Chang, C.-L., Yong, M. G., Lee, J., et al. Mediapipe: A framework for building perception pipelines. ar Xiv preprint ar Xiv:1906.08172, 2019.
Mildenhall, B., Srinivasan, P. P., Tancik, M., Barron, J. T., Ramamoorthi, R., and Ng, R. Nerf: Representing scenes as neural radiance fields for view synthesis. In European Conference on Computer Vision, 2020.
Roich, D., Mokady, R., Bermano, A. H., and Cohen-Or, D. Pivotal tuning for latent-based editing of real images. ACM Trans. Graph., 42(1), August 2022. ISSN 0730-0301. doi: 10.1145/3544777.
Shade, J., Gortler, S., He, L.-w., and Szeliski, R. Layered depth images. In Proceedings of the 25th Annual Conference on Computer Graphics and Interactive Techniques, SIGGRAPH '98, pp. 231-242, New York, NY, USA, 1998. Association for Computing Machinery. ISBN 0897919998. doi: 10.1145/280814.280882.
Shih, M.-L., Su, S.-Y., Kopf, J., and Huang, J.-B. 3d photography using context-aware layered depth inpainting. In Proceedings of the IEEE/CVF Conference on Computer Vision and Pattern Recognition (CVPR), June 2020.
Wang, Z., Bovik, A., Sheikh, H., and Simoncelli, E. Image quality assessment: from error visibility to structural similarity. IEEE Transactions on Image Processing, 13(4):600-612, 2004. doi: 10.1109/TIP.2003.819861.
Wang, Z., Liu, Y.-L., Huang, J.-B., Satoh, S., Ma, S., Krishnan, G., and Wang, J. Disco: Portrait distortion correction with perspective-aware 3d gans. International Journal of Computer Vision, pp. 1-18, 2024.
Xie, J., Ouyang, H., Piao, J., Lei, C., and Chen, Q. High fidelity 3d gan inversion by pseudo-multi-view optimization. In Proceedings of the IEEE/CVF Conference on Computer Vision and Pattern Recognition (CVPR), pp. 321-331, June 2023.
Yu, C., Wang, J., Peng, C., Gao, C., Yu, G., and Sang, N. Bisenet: Bilateral segmentation network for real-time semantic segmentation. In Proceedings of the European Conference on Computer Vision (ECCV), September 2018.
Yuan, Z., Zhu, Y., Li, Y., Liu, H., and Yuan, C. Make encoder great again in 3d gan inversion through geometry and occlusion-aware encoding. In Proceedings of the IEEE/CVF International Conference on Computer Vision (ICCV), pp. 2437-2447 October 2023.
Zhang, R., Isola, P., Efros, A. A., Shechtman, E., and Wang, O. The unreasonable effectiveness of deep features as a perceptual metric. In Proceedings of the IEEE Conference on Computer Vision and Pattern Recognition (CVPR), June 2018.
Zhao, Y., Huang, Z., Li, T., Chen, W., LeGendre, C., Ren, X., Shapiro, A., and Li, H. Learning perspective undistortion of portraits. In Proceedings of the IEEE/CVF International Conference on Computer Vision (ICCV), October 2019.

1. A method, performed by an electronic device, for correcting perspective distortion in a digital image, the method comprising:
obtaining an input image;
processing the input image into a canonical image;
obtaining an input angle for the input image;
obtaining an output angle to be used for generating the output image;
providing the input angle, the output angle and the canonical image as inputs to a pre-trained multi-task neural network model for correcting perspective distortion; and
outputting an image with corrected perspective distortion as the output image.

2. The method of claim 1, further comprising:
predicting, using a warping head of the pre-trained multi-task neural network model, a warping field indicating per-pixel displacement for eliminating the perspective distortion; and
performing image warping based on the warping field to obtain a warped image.

3. The method of claim 2, further comprising:
generating, using a restoration head of the pre-trained multi-task neural network model, a restored image, by predicting an image in which the perspective distortion is reduced.

4. The method of claim 3, further comprising:
generating, using a segmentation head of the pre-trained multi-task neural network model, a segmentation mask; and
applying the segmentation mask to the restored image and the warped image to remove background in the restored image and the warped image.

5. The method of claim 3, further comprising generating a blend mask using a blend mask head of the pre-trained multi-task neural network model, wherein the blend mask comprises coefficients indicating blending ratio between the restored image and the warped image.

6. The method of claim 5, further comprising blending, based on the blend mask, the restored image in which the background is removed and the warped image in which the background is removed.

7. The method of claim 1, further comprising detecting a face in the input image.

8. The method of claim 1, wherein processing the input image into the canonical image comprises at least one of putting a face to a predefined position within the input image, adjusting a rotation of the face, or scaling the face to a predefined scale.

9. The method of claim 1, wherein the pre-trained multi-task neural network model comprises a warping head, a restoration head, a segmentation head, a blend mask head, and a depth head configured to predict per-pixel depth.

10. The method of claim 2, wherein predicting, using the warping head, the warping field comprises obtaining a tensor of shared features F.

11. The method of claim 10, wherein the tensor of shared features F is used to generate a restored image using a restoration head, and to generate a blend mask using a blend mask head.

12. The method of claim 6, wherein the blending the restored image in which the background is removed and the warped image in which the background is removed comprises computing linear interpolation between the warped image in which the background is removed and the restored image in which the background is removed based on the coefficients comprised in the blend mask.

13. An electronic device for correcting perspective distortion in a digital image, the electronic device comprising at least one processor, comprising processing circuitry, and memory storing instructions which, when executed individually or collectively by the at least one processor, cause the electronic device to:
obtain an input image;
process the input image into at least a canonical image;
obtain an input angle for the input image;
obtain an output angle to be used for generating the output image;
provide the input angle, the output angle and the canonical image as inputs to a pre-trained multi-task neural network model for correcting perspective distortion; and
output an image with corrected perspective distortion as the output image.

14. The electronic device of claim 13, wherein the instructions which, when executed individually or collectively by the at least one processor, cause the electronic device to:
predict, using a warping head of the pre-trained multi-task neural network model, a warping field indicating per-pixel displacement for eliminating the perspective distortion; and
perform image warping based on the warping field to obtain a warped image.

15. The electronic device of claim 14, wherein the instructions which, when executed individually or collectively by the at least one processor, cause the electronic device to:
generate, using a restoration head of the pre-trained multi-task neural network model, a restored image, by predicting an image in which the perspective distortion is reduced.

16. The electronic device of claim 15, wherein the instructions which, when executed individually or collectively by the at least one processor, cause the electronic device to:
generate, using a segmentation head of the pre-trained multi-task neural network model, a segmentation mask; and
apply the segmentation mask to the restored image and the warped image to remove background in the restored image and the warped image.

17. The electronic device of claim 15, wherein the instructions which, when executed individually or collectively by the at least one processor, cause the electronic device to:
generate a blend mask using a blend mask head of the pre-trained multi-task neural network model, wherein the blend mask comprises coefficients indicating blending ratio between the restored image and the warped image.

18. The electronic device of claim 17, wherein the instructions which, when executed individually or collectively by the at least one processor, cause the electronic device to:
blend, based on the blend mask, the restored image in which the background is removed and the warped image in which the background is removed.

19. The electronic device of claim 13, wherein the pre-trained multi-task neural network model has an architecture which comprises a backbone model conditioned with the input angle and the output angle; and
the architecture further comprising one or more of:
a warping head configured to generate a warping field indicating per-pixel displacement that removes perspective distortion when applied to the input image;
a restoration head configured to generate a restored image using a tensor of shared features F;
a segmentation head configured to generate a segmentation mask that is used to remove background from the restored image and a warped image;
a blend mask head configured to generate a blend mask that combines the warped image and the restored image into a blended image; or
a depth head configured to predict a depth map of the restored image.

20. A non-transitory computer readable medium having stored thereon a computer program comprising instructions which, when executed by at least one processor of an electronic device, cause the electronic device to perform the method of claim 1.
